(19) United States
(12) Patent Application Publication
(10) Pub. No.: US 2017/0070416 A1
(43) Pub. Date: Mar. 9, 2017

(54) METHOD AND APPARATUS FOR MODIFYING FORWARDING STATES IN A NETWORK DEVICE OF A SOFTWARE DEFINED NETWORK

(71) Applicant: Telefonaktiebolaget L M Ericsson (publ), Stockholm (SE)

(72) Inventors: Bhalaji NARAYANAN, Bangalore (IN); Periyasamy PALANISAMY, Bangalore (IN); Shuva Jyoti KAR, Bangalore (IN); Amudhan GUNASEKARAN, Bangalore (IN); Sasidharan S. SAMBASIVAM, Bangalore (IN)

(21) Appl. No.: 14/846,688

(22) Filed: Sep. 4, 2015

(51) Int. Cl. H04L 12/751; H04L 12/721; H04L 12/715

(52) U.S. Cl. CPC H04L 45/02; H04L 45/64; H04L 45/38

(57) ABSTRACT

A method in a network controller coupled to a network device of a software defined network (SDN), of modifying forwarding table entries of the network device is described. The method includes constructing a first message including a flow profile associated with a plurality of flows and an install profile command, where the flow profile includes a flow profile identifier, and a set of default parameter values that are common for the plurality of flows. The method continues with causing the network device to install the flow profile associated with the plurality of flows.

### FIELD

Embodiments of the invention relate to the field of networking; and more specifically, to modifying forwarding table entries of the network device in a Software Defined Network (SDN).

### BACKGROUND

Software Defined Networking (SDN) is an approach to computer networking that allows network administrators to manage network services through abstraction of lower-level functionality. This is done by decoupling the system that makes decisions about where traffic is sent (the control plane) from the underlying systems that forward traffic to the selected destination (the data plane). In such a system, a network controller, which is typically deployed as a cluster of server nodes, has the role of the control plane and is coupled to one or more network elements that have the role of the data plane. Each network elements being implemented on one or multiple network devices. The control connection between the network controller and network elements is generally a TCP/UDP based communication. The network controller communicates with the network elements using an SDN protocol (e.g., OpenFlow, I2RS, etc.).

For implementing SDN, the Open Networking Foundation (ONF), an industrial consortium focusing on commercializing SDN and its underlying technologies, has defined a set of open commands, functions, and protocols. The defined protocol suites are known as the OpenFlow (OF) protocol. The network controller, acting as the control plane, may then program the data plane on the network elements by causing packet handling rules to be installed on the forwarding network elements using OF commands and messages. These packet handling rules may have criteria to match various packet types as well as actions that may be performed on those packets. For example, the network controller may program the network elements to forward packets with a specific destination address a certain way in the network. The network controller programs the forwarding states on the data-plane (which includes multiple network elements) using flow modification requests. In a large scale deployment, where millions of such equivalent flow commands are being sent, the bandwidth requirement on the control-network can be enormous.

### SUMMARY

Embodiments of the invention relate to a method, in a network controller coupled to a network device of a software defined network (SDN), of modifying forwarding table entries of the network device. The method includes constructing a first message including a flow profile associated with a plurality of flows and an install profile command, where the flow profile includes a flow profile identifier, and a set of default parameter values that are common for the plurality of flows. The method continues with causing the network device to install the flow profile associated with the plurality of flows.

Embodiments of the invention relate to a network controller to be coupled to a network device in a software defined network (SDN). The network controller including: a processor and a memory, said memory containing instructions executable by the processor where the network controller is operative to construct a first message including a flow profile associated with a plurality of flows and an install profile command, where the flow profile includes a flow profile identifier, and a set of default parameter values that are common for the plurality of flows. The network controller is further operative to cause the network device to install the flow profile associated with the plurality of flows.

Embodiments of the invention relate to a method in a network device coupled with a network controller of a software defined network (SDN), the method including: receiving a first message from the network controller, where the first message includes a flow profile associated with a plurality of flows and an install profile command, where the flow profile includes a flow profile identifier, and a set of default parameter values that are common for the plurality of flows; and storing in response to the receiving of the first message, a flow profile entry including the flow profile identifier and the set of default parameter values.

Embodiments of the invention relate to a network device to be coupled to a network controller in a software defined network (SDN). The network device includes a processor and a memory, said memory containing instructions executable by the processor. The network device is operative to receive a first message from the network controller, where the first message includes a flow profile associated with a plurality of flows and an install profile command, where the flow profile includes a flow profile identifier, and a set of default parameter values that are common for the plurality of flows; and to store, in response to the receiving of the first message, a flow profile entry including the flow profile identifier and the set of default parameter values.

### BRIEF DESCRIPTION OF THE DRAWINGS

The invention may best be understood by referring to the following description and accompanying drawings that are used to illustrate embodiments of the invention. In the drawings:

FIG. 1 illustrates a method and system 100 for modification of forwarding states of a network device in accordance with some embodiments of the invention.

FIG. 2A illustrates a flow diagram of operations for identifying the flow profile associated with a plurality of flows in accordance with some embodiments of the invention.

FIG. 2B illustrates a flow diagram of operations for causing the network device to install the flow profile associated with a plurality of flows in accordance with some embodiments of the invention.

FIG. 3 illustrates a flow diagram of operations for modifying a flow at the network device according to some embodiments of the invention.

FIG. 4 illustrates a flow diagram of operations for installing a flow profile associated with multiple flows in accordance with some embodiments of the invention.

FIG. 5 illustrates a flow diagram of operations performed in a network device for modifying a flow in accordance with some embodiments of the invention.

FIG. 6 illustrates an exemplary structure for implementing an OpenFlow message for installing a flow profile and/or modifying a flow in accordance with some embodiments of the invention.

FIG. 7A illustrates exemplary types of command to be transmitted within a message to the network device for installing a flow profile and/or modifying a flow in accordance with some embodiments.

FIG. 7B-7D illustrate an exemplary structures for parameter values to be transmitted within a message to the network device for installing a flow profile and/or modifying a flow in accordance with some embodiments.

FIG. 8A illustrates connectivity between network devices (NDs) within an exemplary network, as well as three exemplary implementations of the NDs, according to some embodiments of the invention.

FIG. 8B illustrates an exemplary way to implement a special-purpose network device according to some embodiments of the invention.

FIG. 8C illustrates various exemplary ways in which virtual network elements (VNEs) may be coupled according to some embodiments of the invention.

FIG. 8D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 8E illustrates the simple case of where each of the NDs implements a single NE, but a centralized control plane has abstracted multiple of the NEs in different NDs into (to represent) a single NE in one of the virtual network(s), according to some embodiments of the invention.

FIG. 8F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 9 illustrates a general purpose control plane device with centralized control plane (CCP) software 950), according to some embodiments of the invention.

### DESCRIPTION OF EMBODIMENTS

The following description describes methods and apparatus for modifying forwarding table entries of the network device. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

Software Defined Networking (SDN) is an approach to computer networking that allows network administrators to manage network services through abstraction of lower-level functionality. This is done by decoupling the system that makes decisions about where traffic is sent (the control plane) from the underlying systems that forward traffic to the selected destination (the data plane). In such a system, a network controller, which is typically deployed as a cluster of server nodes, has the role of the control plane and is coupled to one or more network elements that have the role of the data plane. Each network elements being implemented on one or multiple network devices. The control connection between the network controller and network elements is generally a TCP/UDP based communication. The network controller communicates with the network elements using an SDN protocol (e.g., OpenFlow, I2RS, etc.).

Using OpenFlow, the network controller, acting as the control plane, programs the data plane on the network elements by causing packet handling rules to be installed on the forwarding network elements using OF commands and messages. These packet handling rules may have criteria to match various packet types as well as actions that may be performed on those packets. For example, the network controller may program the network elements to forward packets with a specific destination address a certain way in the network. To install packet handling rules on the forwarding network elements, the network controller transmits flow modification requests causing the modification of forwarding table entries of forwarding tables of a network element. In OpenFlow based SDN, the forwarding states are installed on the forwarding elements using OpenFlow flow modification messages (“flow mod” messages). The flow modification messages have a set of fields consisting of match criteria, instruction and other administrative fields that needs to be populated by the network controller in full for every single flow being installed on the network element.

In an exemplary scenario, when an application of an application layer located north bound of the network controller requires the installation of multiple flows, a request to install each flow (i.e., a flow modification request for the respective flow) is sent to a network device (on which at least part of a network element is implemented). In such a deployment scenario, the control network providing connectivity between the network controller and the forwarding elements of an SDN will be used continuously where the protocol messages will be exchanged between the control and data-plane and vice versa. However, in many scenarios, the flow modification requests may be of similar pattern for multiple flows with only certain fields in the message (i.e., flow modification request) being different. In a large scale deployment, where millions of such equivalent flow modification requests are sent, the bandwidth requirement on the network controller-network device connection (or as may be referred herein below as the “control network”) is enormous. With increase in scale, i.e., when there are thousands (if not millions) of flows (i.e., forwarding elements), the amount of control messages (e.g., flow modification requests, etc.) exchanged between the control plane and the data-plane can increase significantly. In case of disruptions in the control network (i.e., the network controller-network element connection), the resynchronization of the state of the network also requires all the forwarding states to be re-sent to the network elements further increasing the bandwidth used in the control network. Accordingly, additional methods and apparatuses for enabling an efficient forwarding states modification present clear advantages.

The embodiments of the present invention present methods and apparatuses for using flow profiles for programming the forwarding flows (i.e., forwarding states) on a network element such that the network controller acting as the control plane can send only a delta of fields (parameter values) needed to modify a specific forwarding flow while the remaining information (e.g., additional parameters common to multiple flows) can be retrieved from the flow profiles that are already installed on the network element. Thus use of the flow profiles reduces the amount of data being sent in the flow modification messages.

Methods and apparatuses for modifying forwarding states of a network element are hereby disclosed. In one embodiment, a message including a flow profile associated with a plurality of flows and an install profile command is constructed and transmitted to be installed on the network element. The flow profile includes a flow profile identifier and a set of default parameter values which are common to the multiple flows associated with this flow profile. In these embodiments, the installation and/or modification of the flow profile does not affect the forwarding plane of the network element (i.e., the forwarding table entries) and does not disturb the processing of the packets at the network element. At a later stage, another message is constructed to include the flow profile identifier, a set of parameter values associated with a particular flow, as well as a modify-flow command. This latter message is transmitted to be installed on the network element, resulting in the modification of the forwarding states (i.e., the actual forwarding table entries) associated with the particular flow.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

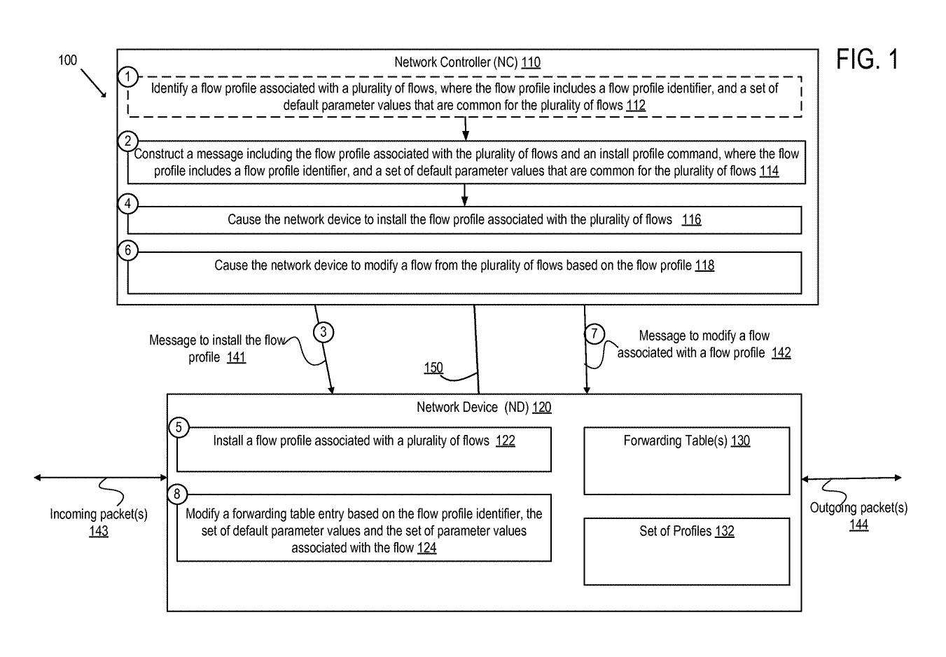

FIG. 1 illustrates a method and system 100 for modification of forwarding states of a network device in accordance with some embodiments. In FIG. 1, the circled numbers are used to denote transactions performed by the elements in the system. The order/sequence of the transactions in FIG. 1 is shown for illustrative purposes, and is not intended to be limitations of the present invention. In one embodiment, the method may be performed by an OpenFlow enabled network element (e.g., a router, a switch, or a bridge), although the scope of the invention is not so limited. As used herein, the term OpenFlow is intended to encompass future versions, future releases, improvements, and extensions to OpenFlow. Moreover, other embodiments are applicable to other protocols besides those that are extensions or derivations of OpenFlow, where a network element is operative to be programmed using flow profiles.

System 100 includes a software-defined network (SDN) represented by network controller (NC) 110 and network device (ND) 120 (which may also be referred herein as a forwarding network device). Although the SDN may include additional NDs controlled by NC 110, they are not shown here for ease of understanding. Thus when the description below refers to ND 120, one can assume that the description may also be referring to additional NDs in the SDN that are controlled by NC 110. In some embodiments, the network device 120 is a physical device implementing a logical network element or a portion of the network element. In some embodiments, a network element can be implemented on multiple network devices. For ease of understanding the embodiments described below refer to the connection and communication established between the network controller and the network device, however one would understand that this may represent a communication between the network controller and the network element including the networking functionality (e.g., router, bridge, or switch).

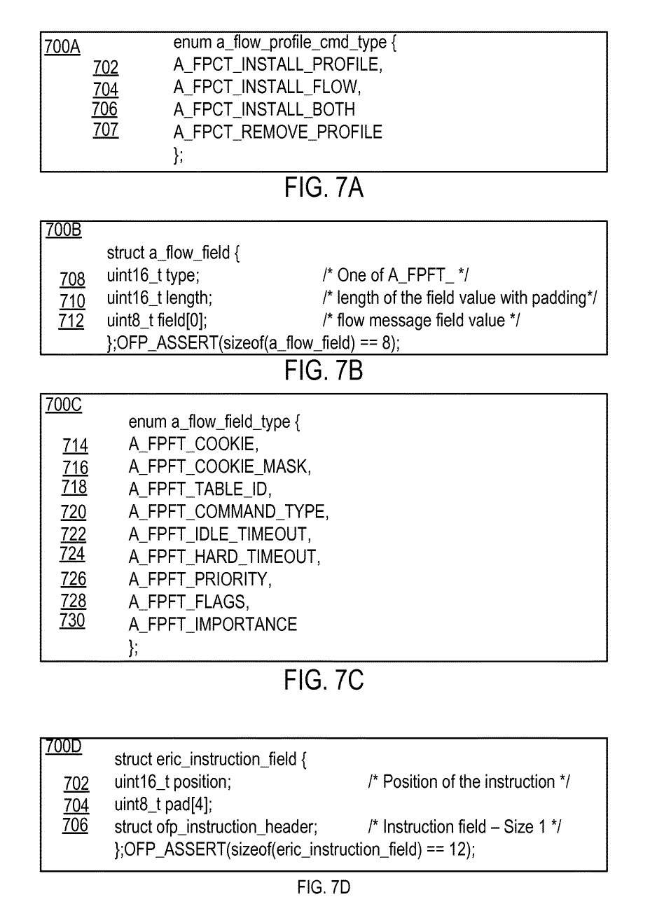

In the illustrated embodiment, the network controller 110 acts as the control plane and the NDs, including ND 120, act as the data plane. The control plane in the SDN communicates with the network devices implementing the data plane using an SDN communications protocol (e.g., OpenFlow; defined by the Open Networking Foundation). The network controller may be implemented on one or more network devices, and each of the NEs may be implemented on one or more network devices. The structure of the SDN is described in further details in reference to FIGS. 7A-D, and 8.

An SDN provides a network administrator with a centrally managed control plane (e.g., the network controller 110) and may simplify management and reduce costs. Unlike a traditional network device where the control plane and data plane reside on one device, separating the control plane and data plane means that control plane and data plane devices are now communicatively coupled using a link, such as link 150. This may introduce additional latencies, bandwidth limitations, and disconnection/connection limitations. In typical scenarios thousands (if not millions) of forwarding states (flows) need to be installed or updated (i.e., modified) on the data plane. The embodiments described with reference to the operations of the circles 1-8 enable the modification of forwarding states of the network device 120 while significantly reducing the amount of data exchanged between the control and the data plane.

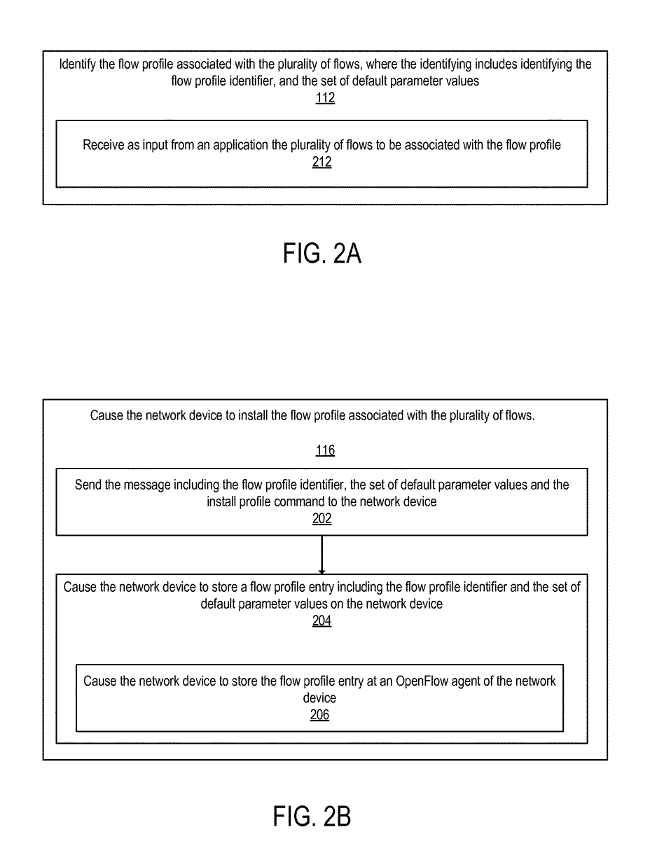

At circle 1, the network controller 110 identifies (112) a flow profile associated with the plurality of flows. Multiple flows are identified as having a similar set of parameter values enabling them to be associated with the same profile. For example, multiple flows may need to be installed on the forwarding device with identical actions, and/or matching criteria. In a non-limiting exemplary scenario, multiple flows may need to be installed when learning subscriber device Media Access Control addresses (MAC addresses) on a given port. In this scenario, multiple subscriber devices (each one having a given MAC address) may be connected to the same port in the SDN. When installing classification flows for the subscriber devices, all fields (i.e., parameters) except the Ethernet source address (i.e., the MAC address of the subscriber device) “Ethernet_src” match field have the same values. In another non-limiting exemplary scenario, multiple flows with common parameter values may need to be installed when performing subscriber classification based on subscribers' device Internet Protocol (IP) addresses. In this scenario, for all subscribers using the same set of services (for e.g., Internet service), when installing the flows (forwarding states), all fields have the same values except the source IP address (in the uplink direction) and destination IP Address (in the downlink direction). FIG. 2A illustrates a flow diagram of operations for identifying the flow profile associated with a plurality of flows. In some embodiments, the identification of the flow profile may include the receipt (212) of an input from an application the plurality of flows to be associated with the flow profile. The network controller 110 may also receive a profile identifier determined through the application to associate with the flows. The profile identifier may be a 64 bits numerical value uniquely associated with the multiple flows (i.e., uniquely associated with the set of default parameters that are common to the multiple flows). However the method is not so limited and the profile identifier may be any N bits numeral value uniquely associated with the multiple flows.

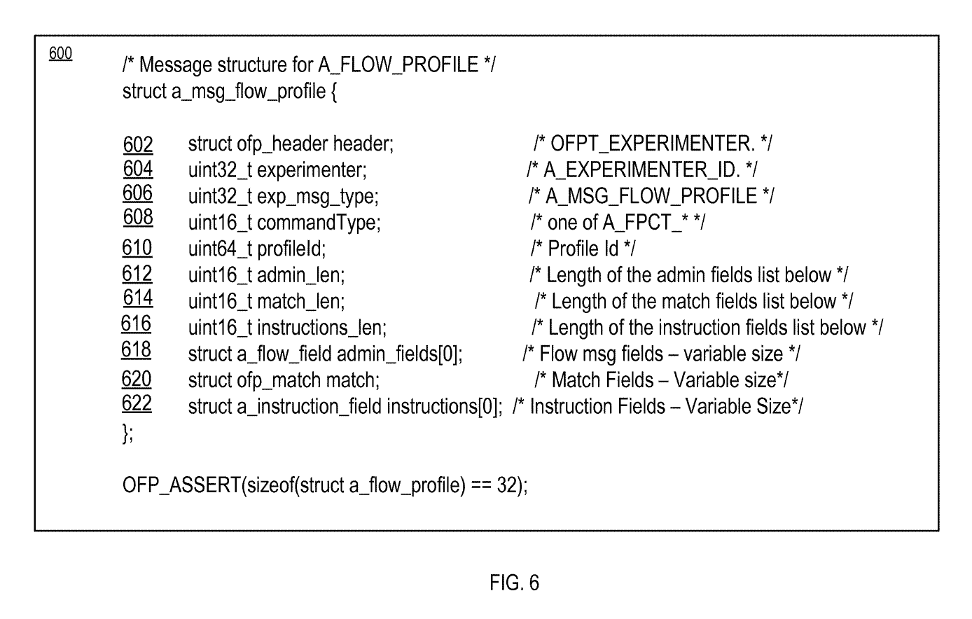

At circle 2, the network controller 110 constructs (114) a message including the flow profile associated with the plurality of flows and an install profile command. The flow profile included in the message includes a flow profile identifier, and a set of default parameter values that are common for the plurality of flows. The set of default parameter values are initial or default values set for parameters that are used to install a flow in a forwarding table entry of the network device. In some embodiments, the message transmitted is an OpenFlow message. In an exemplary embodiment, the message is constructed according to a structure as described in detail with reference to FIG. 6 and FIG. 7A-C.

At circle 3, the constructed message 141 including the flow profile and the profile install command is transmitted through the communication link 150 to the network device. At circle 4, the network controller 110 causes (116) the network device 120 to install the flow profile associated with the plurality of flows. FIG. 2B illustrates a flow diagram of operations for causing the network device to install the flow profile associated with a plurality of flows in accordance with some embodiments. As illustrated in FIG. 2B, the network controller 110 causes the network device 120 to install the flow profile by sending (202) the message 141 to the network device and causing the network device to store (206) a flow profile entry including the flow profile identifier and the set of default parameter values. In some embodiments, the network device 120 is caused to store the flow profile entry at a control agent (e.g., an OpenFlow agent) different from the forwarding agent of the network device. In other words, the installation of the flow profile does not disturb or affect the processing of incoming packets (e.g., incoming packets 143) being currently processed and output (e.g., as outgoing packets 144) at the network device 120.

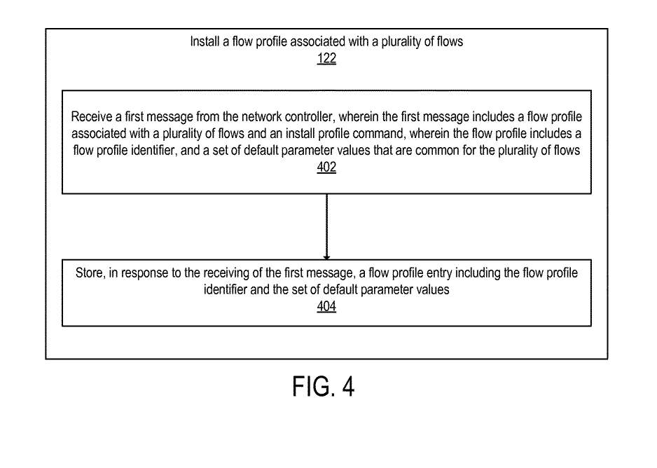

Referring back to FIG. 1, at circle 5, the network device 120 installs (122) a flow profile associated with the flows. FIG. 4, illustrates a flow diagram of operations for installing the flow profile associated with the multiple flows in accordance with some embodiments. At block 402, the network device receives a first message from the network controller (e.g., message 141). The first message includes a flow profile associated with multiple flows and an install profile command. The flow profile includes a flow profile identifier, and a set of default parameter values which are common for the set of flows. In some embodiments, the first message received is constructed by the network controller as described above with reference to circle 2 of FIG. 1, and according to the structure described in further details with reference to FIGS. 6, and 7A-C below. In other embodiments, the message may have a different structure including at least a profile identifier uniquely identifying the particular profile. Flow then moves to block 404, at which the network device 120, stores in response to the receipt of the first message, a flow profile entry including the flow profile identifier and the set of default parameter values as part of the set of flow profiles 132. In some embodiments, the message is an OpenFlow message (e.g., of type experimenter as defined with reference to the structure of FIG. 6) and the flow profile included in the message is stored as an entry in the control agent (OpenFlow agent) of the network device without modifying any of the forwarding tables of the network device 120. Thus the installation of the flow profile associated with multiple flows does not disturb or interfere with the processing of the incoming packets (e.g., packets 143) at the network device.

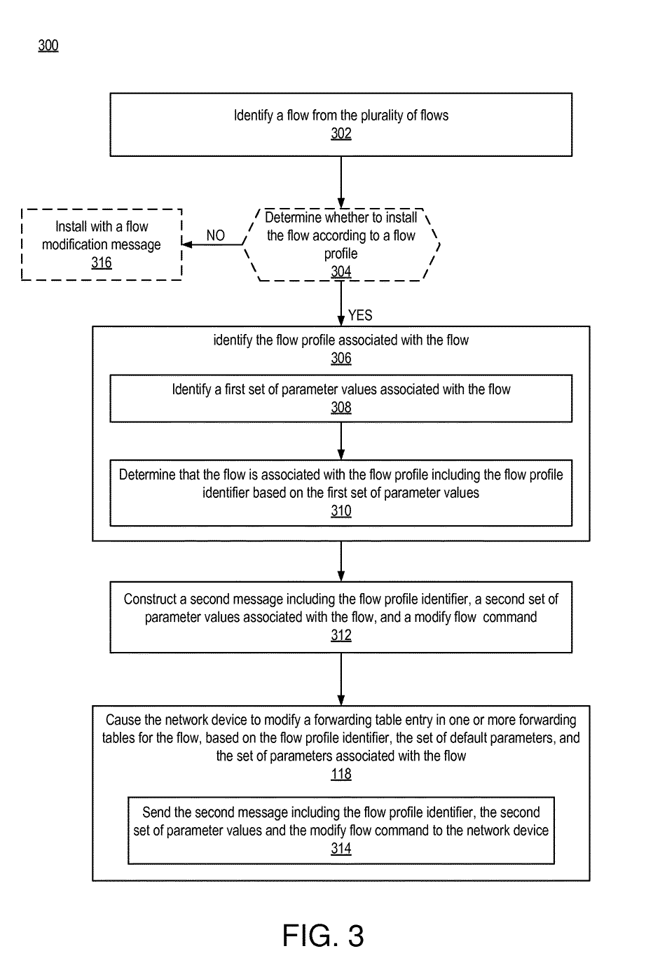

Following the installation of a flow profile, this profile may be used by the network controller 110 to modify a flow (or a forwarding state) on the network device 120. Referring back to FIG. 1, at circle 6, the network controller 110 causes the network device to modify a flow from the multiple flows associated with the flow profile. FIG. 3 illustrates a flow diagram of operations for modifying a flow at the network device according to some embodiments. At block 302, the network controller 110 identifies a flow to be installed on the network device 120. At block 304, the network controller 110 determines, at block 304, whether to install the flow according to a flow profile associated with the flow or using a flow modification message. If the network controller determines that the flow is to be installed with a flow modification message flow then the flow of operations moves to block 316, at which a flow modification message is constructed and transmitted to the network device 120. In some embodiments the flow modification message is a standard OpenFlow “flow mod” message transmitted to the network device for modifying the flow. The modification of this flow in response to the flow mod message will cause the network device to modify or install a forwarding table entry in one or more of the forwarding tables 130. Alternatively if the network controller determines that the flow is to be modified according to a flow profile (e.g., when the network controller 110 determines that the flow is associated with a previously installed flow profile), flow moves to block 306. In some embodiments, the operations performed at block 304, and 316 are optional and may not be performed. In this embodiment, following the identification of the flow at block 312, the flow of operations would move to block 306 at which a flow profile associated with the flow is identified. The flow will then be installed based on the flow profile.

At block 306, the network controller 110 identifies the flow profile associated with the flow to be installed. In some embodiments, the identification of the flow profile may be performed by identifying, at block 308, a first set of parameter values associated with the flow, and determining, at block 310 which flow profile is associated with this particular flow based on this first set of parameter values. In one exemplary embodiment, the first set of parameter values represent a subset of the default parameter values with which the flow profile was installed. In other embodiments, the identification of the flow profile may be performed based on other criteria.

At block 312, the network controller 110, constructs a second message including the flow profile identifier, a set of parameter values associated with the flow and a modify flow command. The set of parameter values transmitted in this second message are parameter values specific to the flow being installed. In some embodiments, this second set of parameter values will be used to override a portion of the default parameters installed with the flow profile associated with this flow. Describe how the message is constructed.

The flow of operations then moves to block 118, at which the network controller 110 causes the network device to modify a forwarding table entry in one or more forwarding tables for the flow, based on the flow profile identifier, the set of default parameters, and the set of parameters associated with the flow. In some embodiments, the network controller sends (314) the second message (e.g., message 142 in circle 7 of FIG. 1) which includes the flow profile identifier, the second set of parameter values and the modify flow command to the network device in order to cause the network device to modify the forwarding table entry. The modification of the forwarding table entry may include modifying an existing forwarding table entry, inserting a new forwarding table entry or deleting an existing forwarding table entry. The action to be performed on the forwarding table entry is determined based on one of the second set of parameter values included in the second message. In some embodiments, the second message received is constructed by the network controller according to the structure described in further details with reference to FIGS. 6, and 7A-C below. However the embodiments are not so limited and the second message may have a different structure.

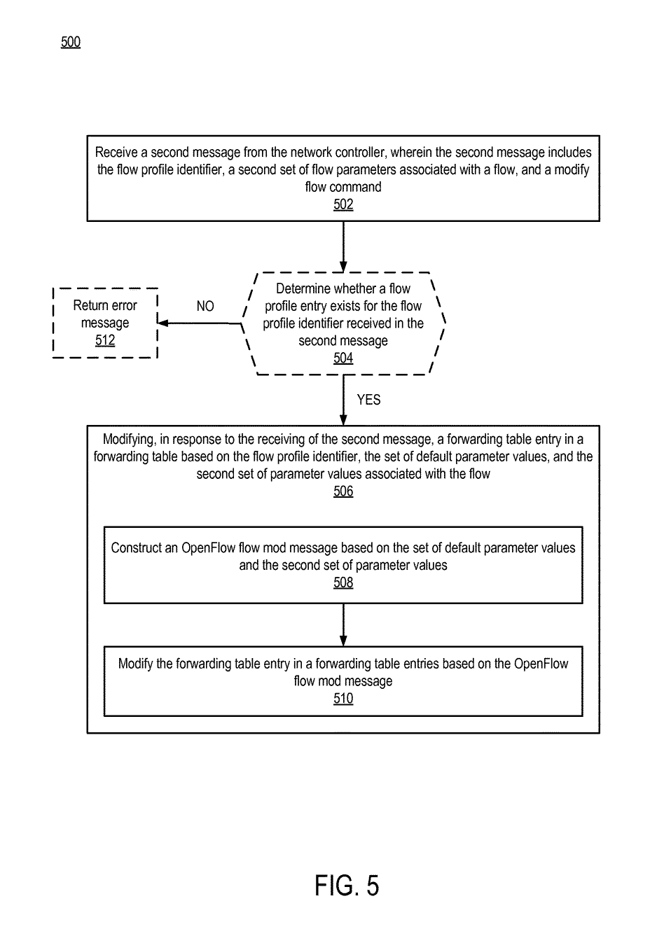

Referring back to FIG. 1, upon receipt of the second message (e.g. message 142) from the network controller 110, the network device 120 modifies, at circle 8 (operation 124), a forwarding table entry based on the flow profile identifier, the set of default parameter values and the set of parameter values associated with the flow. FIG. 5 illustrates a flow diagram of operations performed in a network device for installing a flow in accordance with some embodiments. At block 502, the network device 120 receives the second message from the network controller 110, which includes the flow profile identifier, the second set of parameter values associated with the flow, and the modify flow command. Upon receipt of this message, the network device 120 determines whether the flow profile entry corresponding to the flow to be installed already exists in the set of flow profiles 132. In some embodiments, a lookup is performed in the list of flow profiles 132 based on the flow profile identifier to perform this determination. If the network device determines that the flow profile does not exist, flow moves to block 512 and an error message is returned to the network controller 110. Alternatively, when the network device 120 determines that the flow profile has been previously installed and thus exists in the set of flow profiles 132, the flow of operations moves to block 506. At block 506, the network device modifies, in response to the second message, a forwarding table entry in a forwarding table entry from the forwarding tables 130 based on the flow profile identifier, the set of default parameter values and the second set of parameter values associated with the flow. In some embodiments, upon receipt of a message for installing a flow according to an already installed flow profile, the network device constructs (508) an OpenFlow flow mod message based on the set of default parameter values and the second set of parameter values. The second set of parameter values representing a delta of field values which are specific to the flow being installed when compared with the default parameter values (or default field values) associated with the flow profile. At block 510, the network device modifies a forwarding table entry in a forwarding table from tables 130 based on the OpenFlow flow mod message. The modification of the forwarding table entry may include modifying an existing forwarding table entry, inserting a new forwarding table entry or deleting an existing forwarding table entry. The action to be performed on the forwarding table entry is determined based on one of the second set of parameter values included in the second message.

Thus the embodiments presented above enable a network controller to install a plurality of flows based on an installation of a flow profile while reducing the amount of data exchanged at the control network. The network controller first install the flow profile with a set of default parameter values (fields) and identified with a flow profile identifier, and then enabled the installation of a flow by constructing and transmitting a message which includes only the parameter values (fields) which are specific to this particular flow, as well as the identifier of the flow profile associated with the flow.

FIG. 6 illustrates an exemplary structure for implementing an OpenFlow message for installing a flow profile and/or modifying a flow in accordance with some embodiments. In some embodiments, the message is constructed as an OpenFlow experimenter. The structure 600 of FIG. 6 illustrates an exemplary message structure “a_flow_profile” including the fields 602-622. This structure may be used to create the first message including the profile installation command as well as the second message including the flow installation command. In these embodiments, the extension is identified based on an experimenter identification (ID) (604) (e.g., in an exemplary embodiment A_EXPERIMENTER_ID may be assigned a value of “0x00D0F0DB,” however the embodiments are not so limited and the experimenter_ID may be assigned another value). The message “a_msg_flow_profile” is identified according to a message identification (i.e., message ID) as illustrated in the example below:

```
/* Message types */
enum a_msg {
            /* Flow-profile message */
            A_MSG_FLOW_PROFILE = 1002,
};
```

The a_msg_flow_profile message is used by the network controller 110 to install a profile, a flow, or both on the network device 120. This message may be used to add a flow (e.g., install a new flow according to the OpenFlow command “OFPFC_ADD”), modify an existing flow (according to the OpenFlow command “OFPFC_MODIFY” or “OFPFC_MODIFY_STRICT”). In some embodiments, the same structure 600 is used to construct the first and the second message for respectively installing a flow profile and a flow at the network device. Although only one exemplary structure is presented for constructing the first and the second message, one would understand that the invention is not so limited and that in some embodiments, a first structure may be used to construct the first message and a different structure may be used to construct the second message.

Referring back to FIG. 6, a message for installing a flow profile includes at least the flow profile identifier (610 “profileId”), and a set of default parameter values (e.g., “admin_fields[0]” which are defined by the structure of type “a_flow_field” 618). The profile ID (e.g., “profileid” 610) is used as the key to identify a profile.

In some embodiments, the set of default parameters are defined as illustrated in FIGS. 7B and 7C and will be described in further detail below. In some embodiments, the message structure 600 may further include additional fields. The message may include: a header 602 “ofp_header,” which may be a standard header as per the OpenFlow specification; an experimenter identification (“experimenter” 604) as described above; and a message type (606) which indicates the type of the message, which in this case is a message of type “A_MSG_FLOW_PROFILE” as discussed above. The message further includes a command determining whether to install a flow profile, a flow or both (i.e., the flow profile and the flow).

FIG. 7A illustrates exemplary types of command to be transmitted within a message to the network device for installing a flow profile and/or modifying a flow in accordance with some embodiments. The command type field (“commandType” 608) is of type “a_flow_profile_cmd_type” defined in FIG. 7A. It is used to determine if the message is used to install a profile, a flow or both (i.e., as described with the flow diagrams of FIGS. 1-5, if the message is a first message transmitted from the network controller 110 to the network device to install a flow profile and including a flow profile install command, or alternatively a second message transmitted from the network controller 110 to the network device 120 to install a flow). In some embodiments a third message (i.e., including a third type of command) may be transmitted by the network controller 110 to the network device 120 which results in the installation of both the flow profile and the flow and this is determined based on the type of command included in the message as defined with FIG. 7A. In particular, in some embodiments, when “a_fpct_install_profile” (702) is used, only the profile is installed in the control agent (OpenFlow agent) of the network device 120; when “a_fpct_install_flow” (704) is used, only a flow is modified using an associated profile; and when “a_fpct_install_both” (706) is used both profile and flow are installed. In some embodiments, when “a_fpct_install_flow” (704) is used and the corresponding profile doesn't exist, the profile will be created along with the flow. Flows can be installed, modified or deleted when the command type in the message is “a_fpct_install_flow”. Whether to install/modify/remove the flow is specified using the value of the admin field (a_flow_field) A_fpft_command_type whose value can be Flow ADD, MODIFY, or REMOVE. In some embodiments, when “a_fpct_install_profile” is specified and the profile already exists, then an error is returned to the network controller 110.

In some embodiments, the command types may further include a “a_fpct_remove_profile” (707) command, which can be used to delete a previously installed profile. In other embodiments, the command types does not include the “a_fpct_remove_profile.” In these embodiments, a reboot of the network device 120 may remove previously installed profiles.

At 612, 614 and 616 the length fields are defined in the message structure: “admin_len”, “match_len” and “instruction_len” respectively. These fields indicate the size (length) of the admin_fields (618), the match field (620) and the instruction field (622) respectively, which are specified as part of this message 700.

FIG. 7B-7D illustrate a structure for parameter values to be transmitted within a message to the network device for installing a flow profile and/or modifying a flow in accordance with some embodiments. The parameter values may be either the set of default parameters defined when installing a flow profile or alternatively the set of parameter values associated with the flow when and defined when installing the flow at the network device. Each parameter (field is defined according to a flow field, or a flow parameter structure (e.g., “a_flow_field” structure 700B as illustrated in FIG. 7B). Thus each flow parameter, as defined with respect to the structure 700B, includes a field type (e.g., type 708) which takes one of the values as illustrated and discussed in further detail with respect to FIG. 7C “a_flow_field_type” 700C. In some embodiments, this type includes only one type. The length attribute (710) indicates the length of the field value (or also as referred herein the parameter value). The flow field (or flow parameter) include a field value (or parameter value) 712. The parameter value 712 may be of different types as illustrated in FIG. 7: “a_fpft_cookie” 714, “a_fpft_cookie_mask” 716, “a_fpft_table_id” 718, “a_fpft_command_type” 720, “a_fpft_idle_timeout” 722, “a_fpft_hard_timeout” 724, “a_fpft_priority” 726, “a_fpft_flags” 728, and “a_fpft_importance” 730.

Referring back to FIG. 6, the message 600 further includes a variable list of match fields of structure “ofp_match.” The “ofp_match” field 620, includes the list of matches to be applied to identify a given flow. In some embodiments, this field is defined as specified in the OpenFlow specification. The message 600 may additionally include an instructions field (622) of type “a_instruction_field,” which indicates the position and value of the given instruction. The “a_msg_flow_profile” message includes a list of “a_instruction_field” entries with the position of the action (instruction) specified. In some embodiments, the order at which these instructions are included in the flow profile message is maintained since actions that are part of the instructions can perform modifications to the processed packet. In some embodiments, the instruction field is defined based on the structure illustrated with respect to FIG. 7D such that the position (702) is defined for each instruction (704). In some embodiments the structure of the message described with reference to FIG. 6, may be used to delete a flow profile. In these embodiments a “a_fpct_remove_profile” (707) may be included in the message to indicate the identified profile is to be deleted and removed from the set of flow profiles 132.

The embodiments presented herein, relate to a method and apparatuses for modifying forwarding states (flows) of a network device based on flow profiles. These embodiments, present clear advantages with respect to the prior approaches by enabling the reduction of the amount of data exchanged between the control plane (e.g., network controller 110) and the data-plane (e.g., network device 120) when installing forwarding flows (forwarding states) by sending only the values of the parameters (fields) specific to a particular flow to be installed on the network device. In some embodiments, there is 50% to 70% reduction respectively in the amount of data exchanged when the method described with respect to FIGS. 1-7D is used. Some embodiments presented herein describe a method and an apparatus to reduce the amount of data that an SDN network controller sends to an OpenFlow network device (e.g., a switch) to configure a high number of OpenFlow table entries with similarities. The method described has benefits in reducing the amount of data that needs processing, and the bandwidth on the wire between network controller and network device.

In addition, the embodiments described herein can be used interchangeably with existing flow modification methods of OpenFlow (e.g., installation of flow with “flow mod” messages as per the OpenFlow specification). Thus, these embodiments can be implemented without any change to the OpenFlow specification.

In some embodiments, the methods and apparatuses described with reference to FIGS. 1-7d are used in the context of the installation of forwarding states based on mac learning. in these embodiments, the needed forwarding states are installed in the open-flow pipeline of a network device (e.g., a switch) by matching the Ethernet source mac (ETH_SRC) of the incoming packets. In a traditional approach a flow mod message is transmitted from the network controller to the network device to perform a forwarding state installation when the mac address is learnt on the 12 domain. In this example, a total size of the message can be 96 bytes with an 8 bytes OpenFlow header, 48 bytes of admin fields, 32 bytes of match fields and 8 bytes for the instructions fields. However, in a mac learning scenario, for all hosts attached to the same port in, the network device (data plane node (DPN)) of the SDN domain, all the fields discussed above are the same, except the ETH_SRC match field. Thus, when the flow profile is used to install forwarding states in the context of mac learning, only the delta (the ETH_SRC field) is passed as part of the flow installation message. The total message size will then be 42 bytes, instead of 96 bytes. In this exemplary embodiment, the flow installation message based on the flow profile may include the following: a header (and some mandatory fields) of 32 bytes, and a match field of 10 bytes. Additionally, for the one-time profile installation, a total of 150 bytes is used (including: header+mandatory fields—32 bytes; admin fields—70 bytes; match fields—32 bytes; and instructions—16 bytes).

Table 1, below, illustrates the improvement resulting from the use of the installation of forwarding states based on flow profile, in the particular example of MAC learning and installation of associated flows on a given port when compared with a conventional method (i.e., installing each flow with a flow modification message from the OpenFlow specification):

TABLE 1

| | | | 1000 macs/ | 10000 macs/ |
|---|---|---|---|---|
| | 100 macs/port | | port | port |
| Conventional method | 9600 | bytes | 96000 bytes | 960000 bytes |
| Flow profile based | 4200 + 150 | bytes | 42150 bytes | 420150 bytes |
| method | | | | |

In another example, the methods and apparatuses described with reference to FIGS. 1-7d may be used to perform a forwarding state installation when a subscriber classifier based on IP addresses is installed. According to conventional approaches, the total message size for performing the installation of each flow (forwarding state) is of 128 bytes (including an OpenFlow header of 8 bytes, admin fields of 48 bytes, match fields of 42 bytes, and instructions fields of 32 bytes). In the subscriber classifier flow installation scenario, for different subscribers, all the fields shown above are the same except the IP source (e.g., the IPv4 source address (IPv4_src) or IPv6 source address (IPv6_src)) match field (parameter). in this example, when the method based on flow profiles is used, only the delta (i.e., the IPv4_src field, or IPv6_src field) is transmitted as part of each flow installation message instead of the entire fields presented above with a size of 128 bytes. In this case, with the improved installation method based on the flow profile, the total message size is 44 bytes (including a header+mandatory fields of 32 bytes, and a match field of 12 bytes). Additionally, for the one-time profile installation, a total of 180 bytes is used (header+mandatory fields of 32 bytes, an admin fields of 70 bytes, a match fields of 30 bytes, and an instructions field of 48 bytes).

Table 2, below, illustrates the improvement resulting from the use of the installation of flows (forwarding states) based on a flow profile, in the particular example of subscriber classifier flow and installation of associated flows when compared with conventional methods:

TABLE 2

| | | | 10000 | 1000000 |
|---|---|---|---|---|
| | 100 subscribers | | subscribers | subscribers |
| Conventional | 12800 | bytes | 1280000 bytes | 128000000 bytes |
| method | | | | |
| Flow profile | 4400 + 180 | bytes | 440180 bytes | 44000180 bytes |
| based method | | | | |

According to this example, it can be seen that there is an improvement (reduction in the size of the messages transmitted to the network device from the network controller) of more than 65% with the proposed method.

Architecture

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

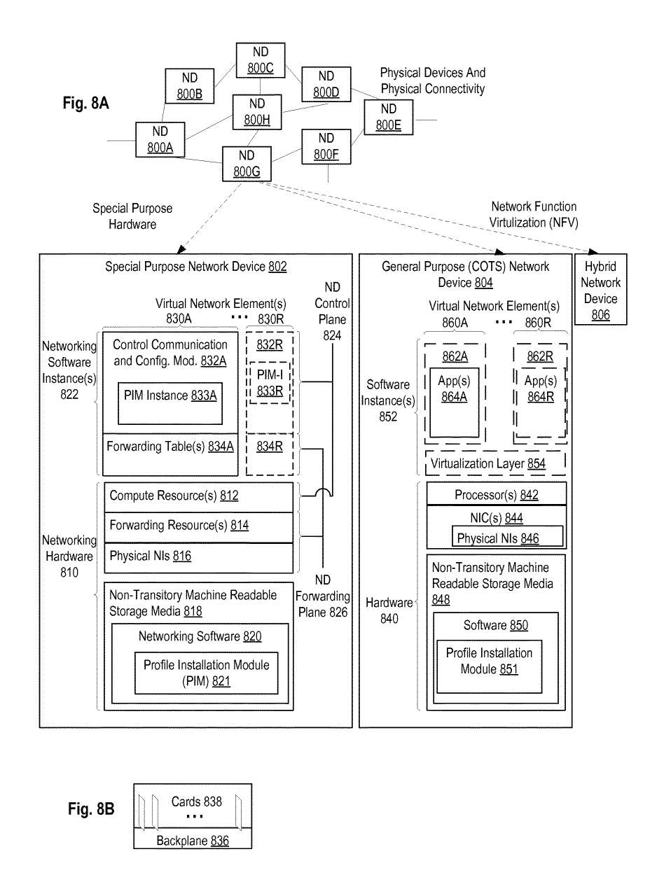

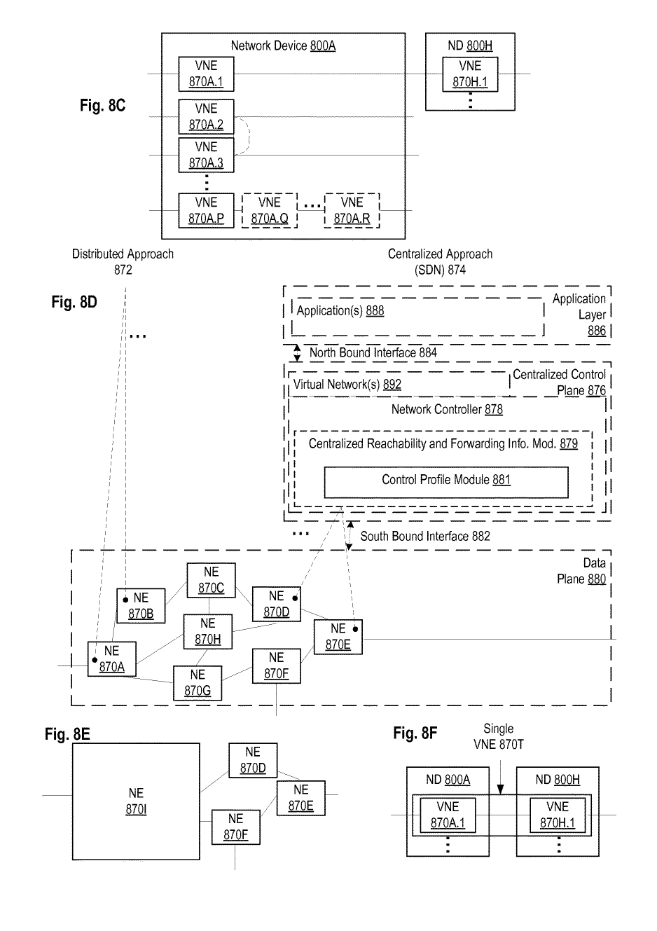

FIG. 8A illustrates connectivity between network devices (NDs) within an exemplary network, as well as three exemplary implementations of the NDs, according to some embodiments of the invention. FIG. 8A shows NDs 800A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 800A, E, and F illustrates that these NDs act as ingress and egress points for the network (and thus, these NDs are sometimes referred to as edge NDs; while the other NDs may be called core NDs).

Two of the exemplary ND implementations in FIG. 8A are: 1) a special-purpose network device 802 that uses custom application-specific integrated-circuits (ASICs) and a proprietary operating system (OS); and 2) a general purpose network device 804 that uses common off-the-shelf (COTS) processors and a standard OS.

The special-purpose network device 802 includes networking hardware 810 comprising compute resource(s) 812 (which typically include a set of one or more processors), forwarding resource(s) 814 (which typically include one or more ASICs and/or network processors), and physical network interfaces (NIs) 816 (sometimes called physical ports), as well as non-transitory machine readable storage media 818 having stored therein networking software 820. The networking software includes a profile installation module (PIM) 821 operative to perform the operations described with reference to FIGS. 1-7D. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 800A-H. During operation, the networking software 820 may be executed by the networking hardware 810 to instantiate a set of one or more networking software instance(s) 822. Each of the networking software instance(s) 822, and that part of the networking hardware 810 that executes that network software instance (be it hardware dedicated to that networking software instance and/or time slices of hardware temporally shared by that networking software instance with others of the networking software instance(s) 822), form a separate virtual network element 830A-R. Each of the virtual network element(s) (VNEs) 830A-R includes a control communication and configuration module 832A-R (sometimes referred to as a local control module or control communication module including PIM instance 833A-R) and forwarding table(s) 834A-R, such that a given virtual network element (e.g., 830A) includes the control communication and configuration module (e.g., 832A including the PIM instance 833A), a set of one or more forwarding table(s) (e.g., 834A), and that portion of the networking hardware 810 that executes the virtual network element (e.g., 830A).

The special-purpose network device 802 is often physically and/or logically considered to include: 1) a ND control plane 824 (sometimes referred to as a control plane) comprising the compute resource(s) 812 that execute the control communication and configuration module(s) 832A-R; and 2) a ND forwarding plane 826 (sometimes referred to as a forwarding plane, a data plane, or a media plane) comprising the forwarding resource(s) 814 that utilize the forwarding table(s) 834A-R and the physical NIs 816. By way of example, where the ND is a router (or is implementing routing functionality), the ND control plane 824 (the compute resource(s) 812 executing the control communication and configuration module(s) 832A-R) is typically responsible for participating in controlling how data (e.g., packets) is to be routed (e.g., the next hop for the data and the outgoing physical NI for that data) and storing that routing information in the forwarding table(s) 834A-R, and the ND forwarding plane 826 is responsible for receiving that data on the physical NIs 816 and forwarding that data out the appropriate ones of the physical NIs 816 based on the forwarding table(s) 834A-R.

FIG. 8B illustrates an exemplary way to implement the special-purpose network device 802 according to some embodiments of the invention. FIG. 8B shows a special-purpose network device including cards 838 (typically hot pluggable). While in some embodiments the cards 838 are of two types (one or more that operate as the ND forwarding plane 826 (sometimes called line cards), and one or more that operate to implement the ND control plane 824 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 836 (e.g., a first full mesh coupling the line cards and a second full mesh coupling all of the cards).

Returning to FIG. 8A, the general purpose network device 804 includes hardware 840 comprising a set of one or more processor(s) 842 (which are often COTS processors) and network interface controller(s) 844 (NICs; also known as network interface cards) (which include physical NIs 846), as well as non-transitory machine readable storage media 848 having stored therein software 850. During operation, the processor(s) 842 execute the software 850 to instantiate one or more sets of one or more applications 864A-R which are operative to perform the operations described with reference to FIGS. 1-7D. While one embodiment does not implement virtualization, alternative embodiments may use different forms of virtualization—represented by a virtualization layer 854 and software containers 862A-R. For example, one such alternative embodiment implements operating system-level virtualization, in which case the virtualization layer 854 represents the kernel of an operating system (or a shim executing on a base operating system) that allows for the creation of multiple software containers 862A-R that may each be used to execute one of the sets of applications 864A-R. In this embodiment, the multiple software containers 862A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 854 represents a hypervisor (sometimes referred to as a virtual machine monitor (VMM)) or a hypervisor executing on top of a host operating system; and 2) the software containers 862A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 864A-R, as well as the virtualization layer 854 and software containers 862A-R if implemented, are collectively referred to as software instance(s) 852. Each set of applications 864A-R, corresponding software container 862A-R if implemented, and that part of the hardware 840 that executes them (be it hardware dedicated to that execution and/or time slices of hardware temporally shared by software containers 862A-R), forms a separate virtual network element(s) 860A-R.

The virtual network element(s) 860A-R perform similar functionality to the virtual network element(s) 830A-R—e.g., similar to the control communication and configuration module(s) 832A and forwarding table(s) 834A (this virtualization of the hardware 840 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 862A-R differently. For example, while embodiments of the invention are illustrated with each software container 862A-R corresponding to one VNE 860A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 862A-R to VNEs also apply to embodiments where such a finer level of granularity is used.

In certain embodiments, the virtualization layer 854 includes a virtual switch that provides similar forwarding services as a physical Ethernet switch. Specifically, this virtual switch forwards traffic between software containers 862A-R and the NIC(s) 844, as well as optionally between the software containers 862A-R; in addition, this virtual switch may enforce network isolation between the VNEs 860A-R that by policy are not permitted to communicate with each other (e.g., by honoring virtual local area networks (VLANs)).

The third exemplary ND implementation in FIG. 8A is a hybrid network device 806, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 802) could provide for para-virtualization to the networking hardware present in the hybrid network device 806.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 830A-R, VNEs 860A-R, and those in the hybrid network device 806) receives data on the physical NIs (e.g., 816, 846) and forwards that data out the appropriate ones of the physical NIs (e.g., 816, 846). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 8C illustrates various exemplary ways in which VNEs may be coupled according to some embodiments of the invention. FIG. 8C shows VNEs 870A.1-870A.P (and optionally VNEs 870A.Q-870A.R) implemented in ND 800A and VNE 870H.1 in ND 800H. In FIG. 8C, VNEs 870A.1-P are separate from each other in the sense that they can receive packets from outside ND 800A and forward packets outside of ND 800A; VNE 870A.1 is coupled with VNE 870H.1, and thus they communicate packets between their respective NDs; VNE 870A.2-870A.3 may optionally forward packets between themselves without forwarding them outside of the ND 800A; and VNE 870A.P may optionally be the first in a chain of VNEs that includes VNE 870A.Q followed by VNE 870A.R (this is sometimes referred to as dynamic service chaining, where each of the VNEs in the series of VNEs provides a different service—e.g., one or more layer 4-7 network services). While FIG. 8C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 8A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 8A may also host one or more such servers (e.g., in the case of the general purpose network device 804, one or more of the software containers 862A-R may operate as servers; the same would be true for the hybrid network device 806; in the case of the special-purpose network device 802, one or more such servers could also be run on a virtualization layer executed by the compute resource(s) 812); in which case the servers are said to be co-located with the VNEs of that ND.

A virtual network is a logical abstraction of a physical network (such as that in FIG. 8A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 8D illustrates a network with a single network element on each of the NDs of FIG. 8A, and within this straight forward approach contrasts a traditional distributed approach (commonly used by traditional routers) with a centralized approach for maintaining reachability and forwarding information (also called network control), according to some embodiments of the invention. Specifically, FIG. 8D illustrates network elements (NEs) 870A-H with the same connectivity as the NDs 800A-H of FIG. 8A.

FIG. 8D illustrates that the distributed approach 872 distributes responsibility for generating the reachability and forwarding information across the NEs 870A-H; in other words, the process of neighbor discovery and topology discovery is distributed.

For example, where the special-purpose network device 802 is used, the control communication and configuration module(s) 832A-R of the ND control plane 824 typically include a reachability and forwarding information module to implement one or more routing protocols (e.g., an exterior gateway protocol such as Border Gateway Protocol (BGP) (RFC 4271), Interior Gateway Protocol(s) (IGP) (e.g., Open Shortest Path First (OSPF) (RFC 2328 and 5340), Intermediate System to Intermediate System (IS-IS) (RFC 1142), Routing Information Protocol (RIP) (version 1 RFC 1058, version 2 RFC 2453, and next generation RFC 2080)), Label Distribution Protocol (LDP) (RFC 5036), Resource Reservation Protocol (RSVP) (RFC 2205, 2210, 2211, 2212, as well as RSVP-Traffic Engineering (TE): Extensions to RSVP for LSP Tunnels RFC 3209, Generalized Multi-Protocol Label Switching (GMPLS) Signaling RSVP-TE RFC 3473, RFC 3936, 4495, and 4558)) that communicate with other NEs to exchange routes, and then selects those routes based on one or more routing metrics. Thus, the NEs 870A-H (e.g., the compute resource(s) 812 executing the control communication and configuration module(s) 832A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 824. The ND control plane 824 programs the ND forwarding plane 826 with information (e.g., adjacency and route information) based on the routing structure(s). For example, the ND control plane 824 programs the adjacency and route information into one or more forwarding table(s) 834A-R (e.g., Forwarding Information Base (FIB), Label Forwarding Information Base (LFIB), and one or more adjacency structures) on the ND forwarding plane 826. For layer 2 forwarding, the ND can store one or more bridging tables that are used to forward data based on the layer 2 information in that data. While the above example uses the special-purpose network device 802, the same distributed approach 872 can be implemented on the general purpose network device 804 and the hybrid network device 806.

FIG. 8D illustrates that a centralized approach 874 (also known as software defined networking (SDN)) that decouples the system that makes decisions about where traffic is sent from the underlying systems that forwards traffic to the selected destination. The illustrated centralized approach 874 has the responsibility for the generation of reachability and forwarding information in a centralized control plane 876 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 876 has a south bound interface 882 with a data plane 880 (sometime referred to the infrastructure layer, network forwarding plane, or forwarding plane (which should not be confused with a ND forwarding plane)) that includes the NEs 870A-H (sometimes referred to as switches, forwarding elements, data plane elements, or nodes). The centralized control plane 876 includes a network controller 878, which includes a centralized reachability and forwarding information module 879 that determines the reachability within the network and distributes the forwarding information to the NEs 870A-H of the data plane 880 over the south bound interface 882 (which may use the OpenFlow protocol). The network controller 878 further includes a control profile module 881 operative to perform the operations described with reference to FIGS. 1-7D. Thus, the network intelligence is centralized in the centralized control plane 876 executing on electronic devices that are typically separate from the NDs.

For example, where the special-purpose network device 802 is used in the data plane 880, each of the control communication and configuration module(s) 832A-R of the ND control plane 824 typically include a control agent that provides the VNE side of the south bound interface 882. In this case, the ND control plane 824 (the compute resource(s) 812 executing the control communication and configuration module(s) 832A-R) performs its responsibility for participating in controlling how data (e.g., packets) is to be routed (e.g., the next hop for the data and the outgoing physical NI for that data) through the control agent communicating with the centralized control plane 876 to receive the forwarding information (and in some cases, the reachability information) from the centralized reachability and forwarding information module 879 (it should be understood that in some embodiments of the invention, the control communication and configuration module(s) 832A-R, in addition to communicating with the centralized control plane 876, may also play some role in determining reachability and/or calculating forwarding information—albeit less so than in the case of a distributed approach; such embodiments are generally considered to fall under the centralized approach 874, but may also be considered a hybrid approach).

While the above example uses the special-purpose network device 802, the same centralized approach 874 can be implemented with the general purpose network device 804 (e.g., each of the VNE 860A-R performs its responsibility for controlling how data (e.g., packets) is to be routed (e.g., the next hop for the data and the outgoing physical NI for that data) by communicating with the centralized control plane 876 to receive the forwarding information (and in some cases, the reachability information) from the centralized reachability and forwarding information module 879; it should be understood that in some embodiments of the invention, the VNEs 860A-R, in addition to communicating with the centralized control plane 876, may also play some role in determining reachability and/or calculating forwarding information—albeit less so than in the case of a distributed approach) and the hybrid network device 806. In fact, the use of SDN techniques can enhance the NFV techniques typically used in the general purpose network device 804 or hybrid network device 806 implementations as NFV is able to support SDN by providing an infrastructure upon which the SDN software can be run, and NFV and SDN both aim to make use of commodity server hardware and physical switches.

FIG. 8D also shows that the centralized control plane 876 has a north bound interface 884 to an application layer 886, in which resides application(s) 888. The centralized control plane 876 has the ability to form virtual networks 892 (sometimes referred to as a logical forwarding plane, network services, or overlay networks (with the NEs 870A-H of the data plane 880 being the underlay network)) for the application(s) 888. Thus, the centralized control plane 876 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 8D shows the distributed approach 872 separate from the centralized approach 874, the effort of network control may be distributed differently or the two combined in certain embodiments of the invention. For example: 1) embodiments may generally use the centralized approach (SDN) 874, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 874, but may also be considered a hybrid approach.

While FIG. 8D illustrates the simple case where each of the NDs 800A-H implements a single NE 870A-H, it should be understood that the network control approaches described with reference to FIG. 8D also work for networks where one or more of the NDs 800A-H implement multiple VNEs (e.g., VNEs 830A-R, VNEs 860A-R, those in the hybrid network device 806). Alternatively or in addition, the network controller 878 may also emulate the implementation of multiple VNEs in a single ND. Specifically, instead of (or in addition to) implementing multiple VNEs in a single ND, the network controller 878 may present the implementation of a VNE/NE in a single ND as multiple VNEs in the virtual networks 892 (all in the same one of the virtual network(s) 892, each in different ones of the virtual network(s) 892, or some combination). For example, the network controller 878 may cause an ND to implement a single VNE (a NE) in the underlay network, and then logically divide up the resources of that NE within the centralized control plane 876 to present different VNEs in the virtual network(s) 892 (where these different VNEs in the overlay networks are sharing the resources of the single VNE/NE implementation on the ND in the underlay network).

On the other hand, FIGS. 8E and 8F respectively illustrate exemplary abstractions of NEs and VNEs that the network controller 878 may present as part of different ones of the virtual networks 892. FIG. 8E illustrates the simple case of where each of the NDs 800A-H implements a single NE 870A-H (see FIG. 8D), but the centralized control plane 876 has abstracted multiple of the NEs in different NDs (the NEs 870A-C and G-H) into (to represent) a single NE 8701 in one of the virtual network(s) 892 of FIG. 8D, according to some embodiments of the invention. FIG. 8E shows that in this virtual network, the NE 8701 is coupled to NE 870D and 870F, which are both still coupled to NE 870E.

FIG. 8F illustrates a case where multiple VNEs (VNE 870A.1 and VNE 870H.1) are implemented on different NDs (ND 800A and ND 800H) and are coupled to each other, and where the centralized control plane 876 has abstracted these multiple VNEs such that they appear as a single VNE 870T within one of the virtual networks 892 of FIG. 8D, according to some embodiments of the invention. Thus, the abstraction of a NE or VNE can span multiple NDs.

While some embodiments of the invention implement the centralized control plane 876 as a single entity (e.g., a single instance of software running on a single electronic device), alternative embodiments may spread the functionality across multiple entities for redundancy and/or scalability purposes (e.g., multiple instances of software running on different electronic devices).

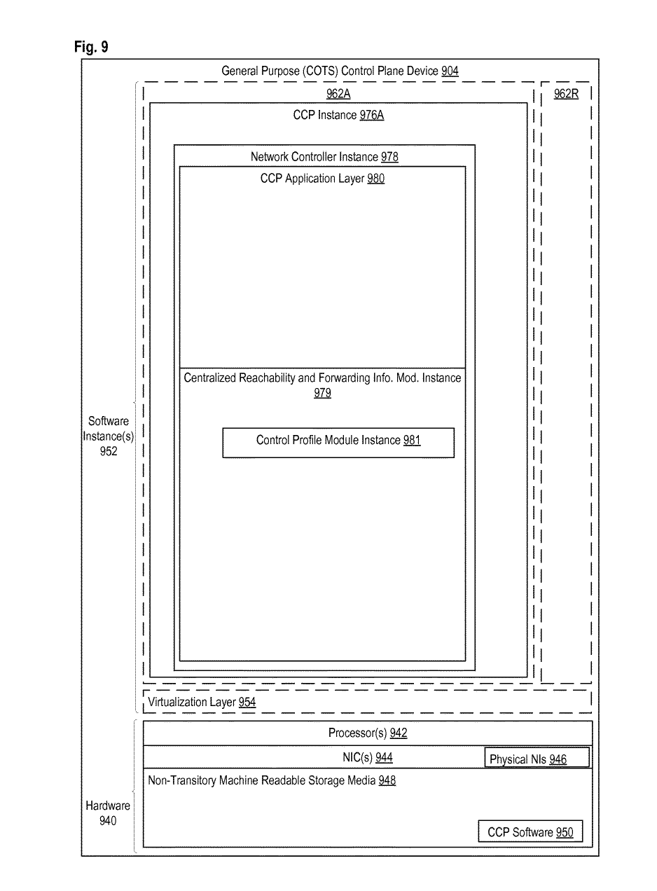

Similar to the network device implementations, the electronic device(s) running the centralized control plane 876, and thus the network controller 878 including the centralized reachability and forwarding information module 879, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 9 illustrates, a general purpose control plane device 904 including hardware 940 comprising a set of one or more processor(s) 942 (which are often COTS processors) and network interface controller(s) 944 (NICs; also known as network interface cards) (which include physical NIs 946), as well as non-transitory machine readable storage media 948 having stored therein centralized control plane (CCP) software 950.

In embodiments that use compute virtualization, the processor(s) 942 typically execute software to instantiate a virtualization layer 954 and software container(s) 962A-R (e.g., with operating system-level virtualization, the virtualization layer 954 represents the kernel of an operating system (or a shim executing on a base operating system) that allows for the creation of multiple software containers 962A-R (representing separate user space instances and also called virtualization engines, virtual private servers, or jails) that may each be used to execute a set of one or more applications; with full virtualization, the virtualization layer 954 represents a hypervisor (sometimes referred to as a virtual machine monitor (VMM)) or a hypervisor executing on top of a host operating system, and the software containers 962A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 950 (illustrated as CCP instance 976A) is executed within the software container 962A on the virtualization layer 954. In embodiments where compute virtualization is not used, the CCP instance 976A on top of a host operating system is executed on the “bare metal” general purpose control plane device 904. The instantiation of the CCP instance 976A, as well as the virtualization layer 954 and software containers 962A-R if implemented, are collectively referred to as software instance(s) 952.

In some embodiments, the CCP instance 976A includes a network controller instance 978. The network controller instance 978 includes a centralized reachability and forwarding information module instance 979 (which is a middleware layer providing the context of the network controller 878 to the operating system and communicating with the various NEs), and an CCP application layer 980 (sometimes referred to as an application layer) over the middleware layer (providing the intelligence required for various network operations such as protocols, network situational awareness, and user-interfaces). At a more abstract level, this CCP application layer 980 within the centralized control plane 876 works with virtual network view(s) (logical view(s) of the network) and the middleware layer provides the conversion from the virtual networks to the physical view. The network controller instance 978 further includes a control profile module instance 981 operative to perform the operations described with reference to FIGS. 1-7D.

The centralized control plane 876 transmits relevant messages to the data plane 880 based on CCP application layer 980 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 10 or more) in the packet headers. Different NDs/NEs/VNEs of the data plane 880 may receive different messages, and thus different forwarding information. The data plane 880 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 880, the packet (or a subset of the packet header and content) is typically forwarded to the centralized control plane 876. The centralized control plane 876 will then program forwarding table entries into the data plane 880 to accommodate packets belonging to the flow of the unknown packet. Once a specific forwarding table entry has been programmed into the data plane 880 by the centralized control plane 876, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path—multiple equal cost next hops), some additional criteria is used—for instance, in a connectionless network, Equal Cost Multi Path (ECMP) (also known as Equal Cost Multi Pathing, multipath forwarding and IP multipath) (RFC 2991 and 2992) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1 Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) (RFC 793 and 1180) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit (RFC 1180, 955, and 1644) is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS) (RFC 3031), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) (RFC 4761 and 4762) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service) (RFC 4761 and 4762). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VoD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method, in a network controller coupled to a network device of a software defined network (SDN), of modifying forwarding table entries of the network device, the method comprising:
constructing a first message including a flow profile associated with a plurality of flows and an install profile command, wherein the flow profile includes a flow profile identifier, and a set of default parameter values that are common for the plurality of flows; and
causing the network device to install the flow profile associated with the plurality of flows.

2. The method of claim 1, wherein the causing includes:
sending the first message including the flow profile identifier, the set of default parameter values and the install profile command to the network device; and
causing the network device to store a flow profile entry including the flow profile identifier and the set of default parameter values on the network device.

3. The method of claim 1, wherein the causing the network device to store a flow profile entry, includes causing the network device to store the flow profile entry at an OpenFlow agent of the network device.

4. The method of claim 1, wherein the method further comprises:
causing the network device to modify a flow from the plurality of flows based on the flow profile.

5. The method of claim 4, wherein the causing to modify the flow includes:
identifying the flow from the plurality of flows;
identifying the flow profile associated with the flow from the plurality of flows, wherein the flow profile includes the flow profile identifier;
constructing a second message including the flow profile identifier, a set of parameter values associated with the flow, and a modify flow command; and
causing the network device to modify a forwarding table entry in a forwarding table for the flow, based on the flow profile identifier, the set of default parameter values, and the set of parameter values associated with the flow.

6. The method of claim 5, wherein to modify the forwarding table entry includes to install a new forwarding table entry in the forwarding table.

7. The method of claim 5, wherein to modify the forwarding table entry includes to modify an existing forwarding table entry in the forwarding table.

8. The method of claim 1, further comprising prior to the constructing: identifying the flow profile associated with the plurality of flows, wherein the identifying includes identifying the flow profile identifier, and the set of default parameter values.

9. The method of claim 8, wherein identifying a flow profile includes receiving as input from an application the plurality of flows to be associated with the flow profile.

10. A network controller to be coupled to a network device in a software defined network (SDN), comprising:
a processor and a memory, said memory containing instructions executable by the processor whereby the network controller is operative to:
construct a first message including a flow profile associated with a plurality of flows and an install profile command, wherein the flow profile includes a flow profile identifier, and a set of default parameter values that are common for the plurality of flows; and
cause the network device to install the flow profile associated with the plurality of flows.

11. The network controller of claim 10, wherein to cause the network device to install the flow profile includes:
to send the first message including the flow profile identifier, the set of default parameter values and the install profile command to the network device; and
to cause the network device to store a flow profile entry including the flow profile identifier and the set of default parameter values on the network device.

12. The network controller of claim 10, wherein to cause the network device to store a flow profile entry, includes causing the network device to store the flow profile entry at an OpenFlow agent of the network device.

13. The network controller of claim 10, wherein the network controller is further operative to:
cause the network device to modify a flow from the plurality of flows based on the flow profile.

14. The network controller of claim 13, wherein the network controller is further operative to:
identifying the flow from the plurality of flows;
identifying the flow profile associated with the flow from the plurality of flows, wherein the flow profile includes the flow profile identifier;
constructing a second message including the flow profile identifier, a set of parameter values associated with the flow, and a modify flow command; and
causing the network device to modify a forwarding table entry in a forwarding table for the flow, based on the flow profile identifier, the set of default parameter values, and the set of parameter values associated with the flow.

15. The network controller of claim 14, wherein to modify the forwarding table entry includes to install a new forwarding table entry in the forwarding table.

16. The network controller of claim 14, wherein to modify the forwarding table entry includes to modify an existing forwarding table entry in the forwarding table.

17. The network controller of claim 10, wherein the network controller is further operative, prior to construct the first message, to identify the flow profile associated with the plurality of flows, wherein to identify includes to identify the flow profile identifier, and the set of default parameter values.

18. The network controller of claim 17, wherein identifying a flow profile includes receiving as input from an application the plurality of flows to be associated with the flow profile.

19. A method in a network device coupled with a network controller of a software defined network (SDN), the method comprising:
receiving a first message from the network controller, wherein the first message includes a flow profile associated with a plurality of flows and an install profile command, wherein the flow profile includes a flow profile identifier, and a set of default parameter values that are common for the plurality of flows; and
storing, in response to the receiving of the first message, a flow profile entry including the flow profile identifier and the set of default parameter values.

20. The method of claim 19, wherein the first message is an OpenFlow message and the storing includes storing the flow profile entry in an OpenFlow agent of the network device without modifying forwarding tables of the network device.

21. The method of claim 19 further comprising:
Receiving a second message from the network controller, wherein the second message includes the flow profile identifier, a set of parameter values associated with a flow, and a modify flow command; and
modifying, in response to the receiving of the second message, a forwarding table entry in a forwarding table of the network device based on the flow profile identifier, the set of default parameter values, and the set of parameter values associated with the flow.

22. A network device to be coupled to a network controller in a software defined network (SDN), comprising:
a processor and a memory, said memory containing instructions executable by the processor whereby the network device is operative to:
receive a first message from the network controller, wherein the first message includes a flow profile associated with a plurality of flows and an install profile command, wherein the flow profile includes a flow profile identifier, and a set of default parameter values that are common for the plurality of flows; and
store, in response to the receiving of the first message, a flow profile entry including the flow profile identifier and the set of default parameter values.

23. The network device of claim 22, wherein the network device is further operative to:
receive a second message from the network controller, wherein the second message includes the flow profile identifier, a set of parameter values associated with a flow, and a modify flow command; and
modify, in response to the receiving of the second message, a forwarding table entry in a forwarding table of the network device based on the flow profile identifier, the set of default parameter values, and the set of parameter values associated with the flow.
